(19) United States
(12) Patent Application Publication
(10) Pub. No.: US 2025/0216646 A1
(43) Pub. Date: Jul. 3, 2025

(54) LENS DRIVING APPARATUS AND CAMERA MODULE

(71) Applicant: ALPS ALPINE CO., LTD., Tokyo (JP)

(72) Inventors: Katsuhiko OTOMO, Miyagi (JP); Kozo MATSUO, Santa Clara, CA (US)

(21) Appl. No.: 19/001,090

(22) Filed: Dec. 24, 2024

(30) Foreign Application Priority Data
Dec. 28, 2023 (JP) 2023-222347

(51) Int. Cl. G02B 7/09; G03B 13/36; G03B 17/12

(52) U.S. Cl. CPC G02B 7/09; G03B 13/36; G03B 17/12

(57) ABSTRACT

A lens driving apparatus includes a fixed member, a lens holding member having a tubular part capable of holding a lens body, a support member, and a driving part that has a coil and magnets, wherein the lens holding member has a flange and a regulation part, wherein the flange has a first notch and a second notch, a first holding part provided corresponding to the first notch, and a second holding part provided corresponding to the second notch, wherein the coil has a winding part, a first extended part, and a second extended part, wherein the winding part has winding layers, and wherein a first turn of a wire annular portion of the winding part connected to the first extended part includes a first portion and a second portion, the first portion being positioned in a first region, and the second portion being positioned in a second region.

The present application is based on and claims priority to Japanese patent application No. 2023-222347 filed on Dec. 28, 2023, with the Japanese Patent Office, the entire contents of which are hereby incorporated by reference.

### BACKGROUND OF THE INVENTION

### 1. Field of the Invention

The present disclosure relates to lens driving apparatuses and camera modules mounted on, for example, portable devices with cameras.

### 2. Description of the Related Art

Conventionally, a lens driving apparatus to drive a lens holding member along an optical axis direction by a driving part composed of a coil wound around an outer periphery of the lens holding member and a magnet attached to a fixed member has been known (see Patent Literature (PTL) 1). This lens driving apparatus is configured so that a winding start part and a winding end part of a wire constituting the coil are arranged in opposite directions across the optical axis.

However, in the above-described lens driving apparatus, the wire constituting the coil is wound around the lens holding member so that a number of turns of the wire constituting an outermost layer differs by one turn in one semi-annular portion and the other semi-annular portion existing between the winding start part and the winding end part. That is, the wire constituting the coil is wound around the lens holding member so that one semi-annular portion is shorter than the other semi-annular portion by a half turn. Therefore, when a current flows through the coil, there is concern that a slight difference in electromagnetic force may be generated between the coil and the magnet.

Therefore, it is desirable to provide a lens driving apparatus capable of preventing such difference in the electromagnetic force caused by a difference in the winding number of the wire.

### CITATION LIST

### Patent Literature

[PTL 1] Japanese Laid-Open Patent Publication No. 2020-095067

### SUMMARY OF THE INVENTION

A lens driving apparatus according to embodiments of the present disclosure includes a fixed member, a lens holding member having a tubular part capable of holding a lens body, a support member configured to movably support the lens holding member in an optical axis direction, and a driving part that has at least a coil provided outside the tubular part of the lens holding member and a plurality of magnets facing the coil, and that moves the lens holding member in the optical axis direction, wherein the lens holding member has a flange protruding radially outward from a surface of an outer periphery of the tubular part, and a regulation part facing the flange and spaced from the flange in the optical axis direction, wherein the flange has a first notch and a second notch formed at positions opposite each other across the tubular part, a first holding part provided corresponding to the first notch, and a second holding part provided corresponding to the second notch, wherein the coil has a winding part formed by winding a wire around the outer periphery of the tubular part between one surface of the flange part and the regulation part, a first extended part connected to a winding start part of the winding part, and a second extended part connected to a winding end part of the winding part, wherein the first extended part passes through the first notch and is held by the first holding part, and the second extended part passes through the second notch and is held by the second holding part, wherein the winding part has a plurality of winding layers stacked radially outward from an outer peripheral surface of the tubular part, and wherein a first turn of a wire annular portion of the winding part connected to the first extended part includes a first portion and a second portion, the first portion being positioned in a first region extending from the first notch to the second notch in a circumferential direction along the outer peripheral surface of the tubular part, the second portion being positioned in a second region extending from the second notch to the first notch in the circumferential direction, the second region being different from the first region, and the second portion being located nearer to the regulation part than the first portion by a distance substantially equal to a thickness of the wire.

The above-described lens driving apparatus can prevent the difference in electromagnetic force caused by the difference in the number of turns of the wire.

### BRIEF DESCRIPTION OF THE DRAWINGS

FIG. 1 is a perspective view of a lens driving apparatus;

FIG. 2 is an exploded perspective view of the lens driving apparatus;

FIG. 3 is a perspective view from above of the lens driving apparatus with some components removed;

FIG. 4 is a perspective view from above of a lens holding member;

FIG. 5 is a perspective view from below of the lens holding member;

FIG. 6 is a bottom view of the lens driving apparatus with some components removed;

FIG. 7 is a drawing illustrating an example of a connection structure between a flat spring holding member, a yoke, and an upper flat spring;

FIG. 8 is a bottom view of the lens holding member, a coil, and a lower flat spring;

FIG. 9 is a right side view of the lens holding member, the coil, and the lower flat spring;

FIG. 10 is a perspective view from above of metal members and a base member;

FIG. 11 is a left side view of the lens holding member;

FIG. 12 is a right side view of the lens holding member;

FIG. 13 is a front view and a front cross-sectional view of the lens holding member;

FIG. 14 is a right side view and a right cross-sectional view of the lens holding member;

FIG. 15 is a rear view and left side view of the lens holding member;

FIG. 16 is a front cross-sectional view of the lens holding member;

FIG. 17 is a right side cross-sectional view of the lens holding member;

FIG. 18 is a front and front cross-sectional view of the lens holding member;

FIG. 19 is a right side and right side cross-sectional view of the lens holding member;

FIG. 20 is a rear and left side view of the lens holding member;

FIG. 21 is a front cross-sectional view of the lens holding member; and

FIG. 22 is a right side cross-sectional view of a lens holding member.

### DESCRIPTION OF THE PREFERRED EMBODIMENTS

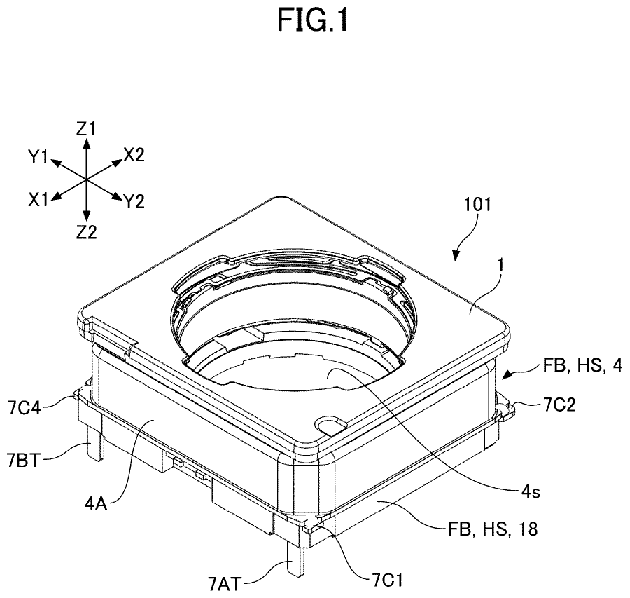

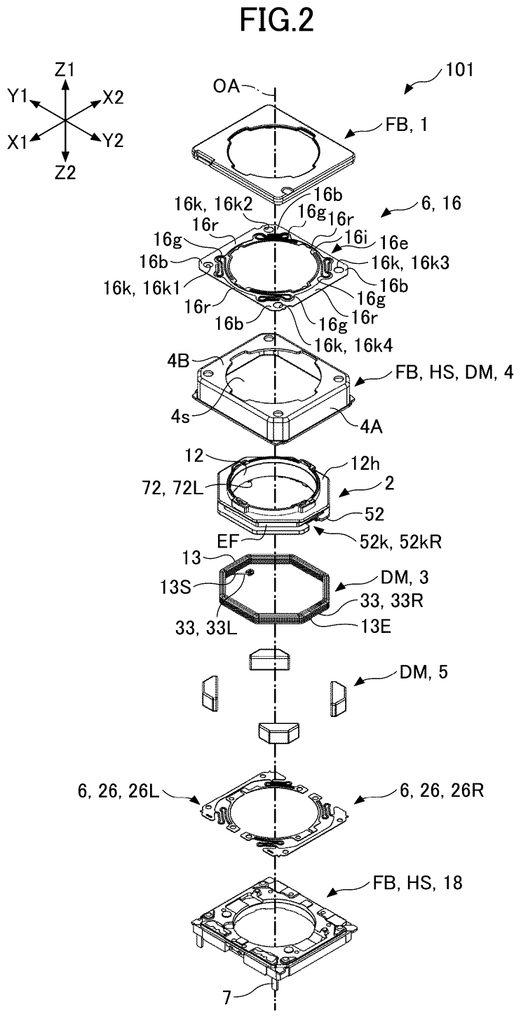

Hereinafter, a lens driving apparatus 101 according to an embodiment of the present invention will be described with reference to the drawings. FIG. 1 is a perspective view of a lens driving apparatus 101, and FIG. 2 is an exploded perspective view of the lens driving apparatus 101. In FIGS. 1 and 2, X1 represents one direction of an X-axis constituting a three-dimensional rectangular coordinate system, and X2 represents the other direction of the X-axis. Y1 represents one direction of a Y-axis constituting the three-dimensional rectangular coordinate system, and Y2 represents the other direction of the Y-axis. Z1 represents one direction of a Z-axis constituting the three-dimensional rectangular coordinate system, and Z2 represents the other direction of the Z-axis. In FIG. 1, X1 direction of the lens driving apparatus 101 corresponds to a front (front face) of the lens driving apparatus 101, and X2 direction of the lens driving apparatus 101 corresponds to the rear (rear face) of the lens driving apparatus 101. Y1 direction of the lens driving apparatus 101 corresponds to a left face of the lens driving apparatus 101, and Y2 direction of the lens driving apparatus 101 corresponds to a right face of the lens driving apparatus 101. Z1 direction of the lens driving apparatus 101 corresponds to a top (direction facing a subject) of the lens driving apparatus 101, and Z2 direction of the lens driving apparatus 101 corresponds to a bottom (direction facing an imaging sensor) of the lens driving apparatus 101. The same applies to other members in other drawings.

As shown in FIG. 2, the lens driving apparatus 101 includes a lens holding member 2 capable of holding a lens body (not shown), a driving part DM for moving the lens holding member 2 along the optical axis direction (Z-axis direction), flat springs 6 as supporting members for supporting the lens holding member 2 movably in the optical axis direction, a fixed member FB to which the flat springs 6 are fixed, and metal members 7 for electrically connecting an external power source with the lens driving apparatus 101. The lens body is, for example, a tubular lens barrel provided with at least one lens, and is configured so that its central axis is along the optical axis direction. The optical axis direction includes the direction of the optical axis OA with respect to the lens body and the direction parallel to the optical axis OA.

As shown in FIG. 2, the driving part DM includes a coil 3 wound around the lens holding member 2, a yoke 4 as a cover member that also functions as an outer case in a rectangular box shape, and four magnets 5 arranged facing four corners of the yoke 4. In the present embodiment, the magnets 5 have a quadrangular prism shape with a trapezoidal bottom surface. The fixed member FB includes a flat spring holding member 1, the yoke 4, and a base member 18 in which metal members 7 are embedded. The flat springs 6 include an upper flat spring 16 connecting the lens holding member 2 and the yoke 4, and lower flat springs 26 connecting the lens holding member 2 and the base member 18. The lower flat springs 26 include a lower left flat spring 26L and a lower right flat spring 26R.

As shown in FIG. 1, the lens driving apparatus 101 has a substantially rectangular parallelepiped shape and is mounted on a substrate (not shown) on which an imaging sensor (not shown) is mounted. A camera module is composed of a substrate, a lens driving apparatus 101, a lens body mounted on a lens holding member 2, and an imaging sensor mounted on the substrate so as to face the lens body. The coil 3 is connected to a power source via the lower flat springs 26, the metal members 7, and the substrate. When a current flows through the coil 3, the driving part DM generates an electromagnetic force along the optical axis direction.

The lens driving apparatus 101 uses this electromagnetic force to achieve an automatic focusing function by moving the lens holding member 2 along the optical axis direction in a Z1 direction (facing the subject) of the imaging sensor. Specifically, the lens driving apparatus 101 moves the lens holding member 2 in a direction away from the imaging sensor to enable macro photography, and moves the lens holding member 2 in a direction approaching the imaging sensor to enable infinity photography.

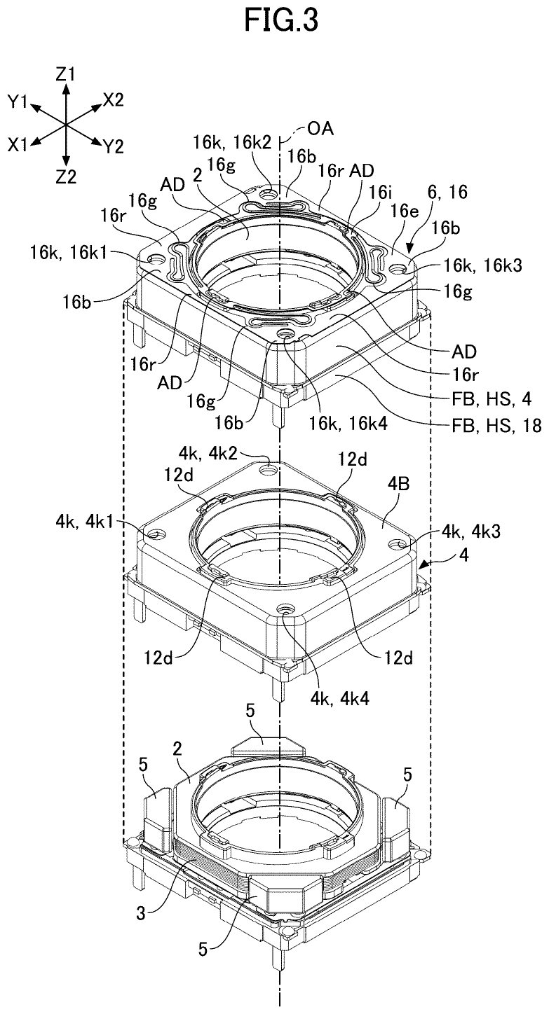

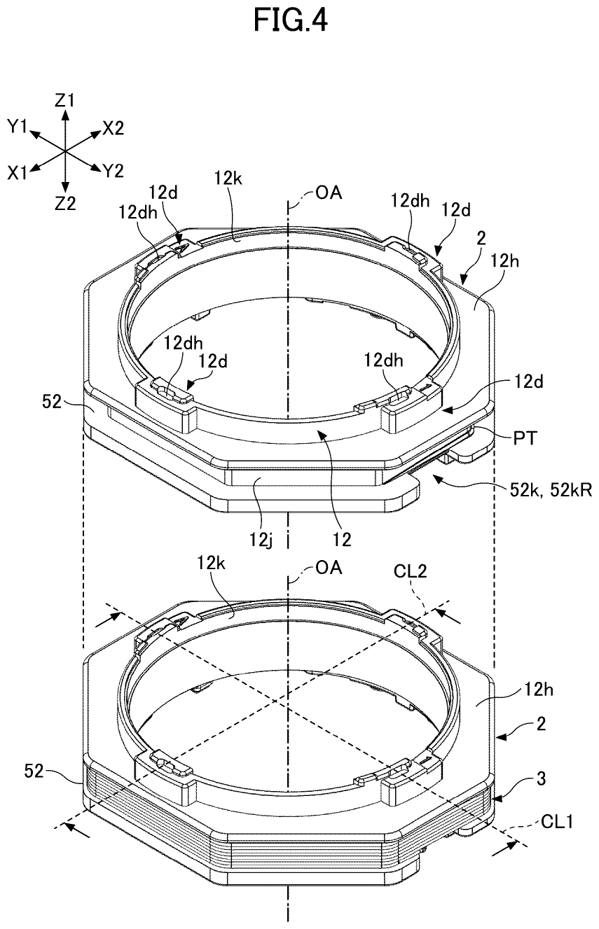

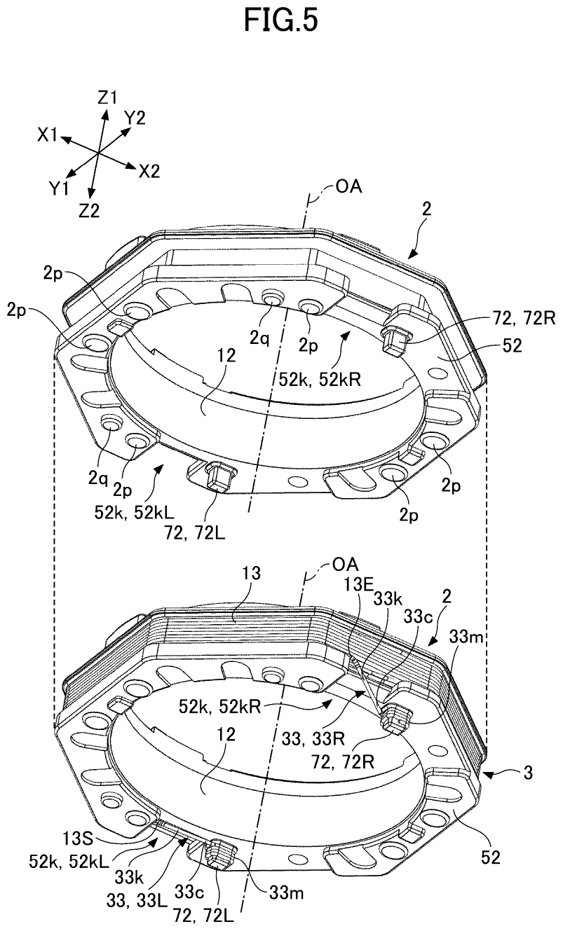

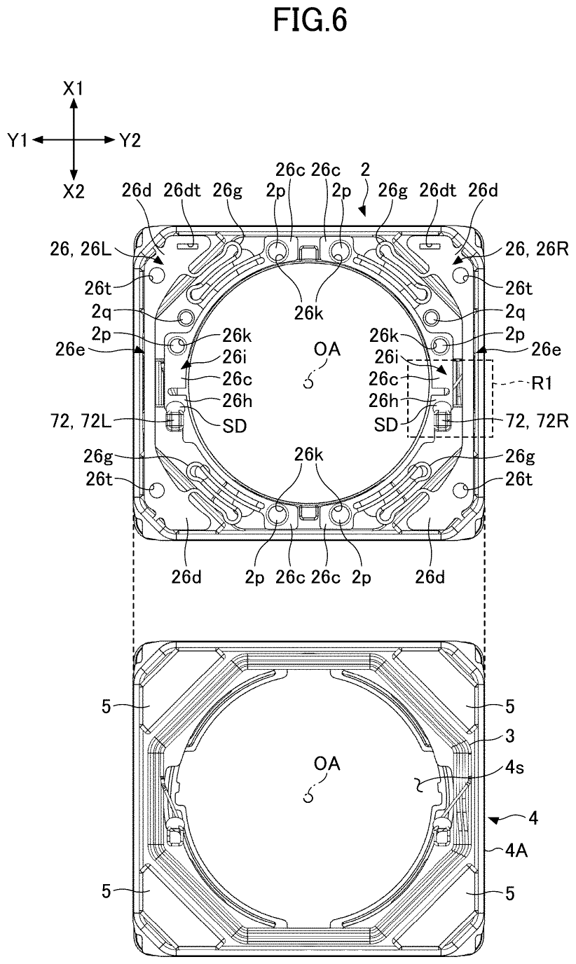

Next, a positional relation between the lens holding member 2 and the driving part DM will be described with reference to FIGS. 3 to 6. FIG. 3 is a perspective view from above of the lens driving apparatus 101 in a state where a part of components is removed. Specifically, the upper drawing of FIG. 3 is a perspective view from above of the lens driving apparatus 101 in a state where the flat spring holding member 1 is removed, the center drawing of FIG. 3 is a perspective view from above of the lens driving apparatus 101 in a state where the upper flat spring 16 is removed, and the lower drawing of FIG. 3 is a perspective view from above of the lens driving apparatus 101 in a state where the yoke 4 is removed. FIG. 4 is a perspective view from above of the lens holding member 2, and FIG. 5 is a perspective view from below of the lens holding member 2. Specifically, the upper drawing of FIG. 4 and the upper drawing of FIG. 5 are views of the lens holding member 2 in which the coil 3 is not wound, and the lower drawing of FIG. 4 and the lower drawing of FIG. 5 are views of the lens holding member 2 in which the coil 3 is wound. FIG. 6 is a bottom view of the lens holding member 2 in a state where some of the components are removed. Specifically, the upper drawing of FIG. 6 is a bottom view of the lens driving apparatus 101 in a state where the metal members 7 and the base member 18 are removed, and the lower drawing of FIG. 6 is a bottom view of the lens driving apparatus 101 in a state where the lower flat springs 26 and the lens holding member 2 are removed.

In the illustrated example, the lens holding member 2 is formed by injecting and molding synthetic resin such as liquid crystal polymer (LCP). Specifically, as shown in FIG. 4, the lens holding member 2 includes a tubular part 12 formed to have an opening 12k which is a through-hole along the optical axis direction, and a flange 52 formed at an end part in the direction facing the imaging device (Z2 direction) in the optical axis direction. The tubular part 12 is formed to be substantially circular and tubular at an end part in the direction facing the subject (Z1 direction) in the optical axis direction.

The lens body is fixed to the inside of the tubular part 12 using an adhesive. Spiral grooves may be provided on the inner peripheral surface of the tubular part 12. This is to enhance the adhesive strength between the lens body and the tubular part 12. Four pedestal parts 12d having recesses 12dh are provided on the end surface of the tubular part 12 on the surface facing the subject so as to surround the optical axis OA. As shown in FIG. 3, the inner portion 16i of the upper flat spring 16 is placed on the pedestal part 12d.

As shown in the upper drawing of FIG. 4, a coil supporting part 12j serving as an outer peripheral wall for supporting the coil 3 is provided on the outer peripheral surface of the tubular part 12. In the present embodiment, the coil supporting part 12j is formed in an octagonal shape so as to support the octagonal shape coil 3. On the surface facing the subject of the coil supporting part 12j, a regulation part 12h is formed which protrudes radially outward so as to face the flange 52 in the optical axis direction. As shown in the lower drawing of FIG. 4, the coil 3 is wrapped in an octagonal shape around the outer peripheral surface of the lens holding member 2 so as to be supported by the coil supporting part 12j and interposed between the regulation part 12h and the flange 52 in the optical axis direction. In the illustrated example, the coil 3 is held by the lens holding member 2 without using an adhesive, but may be fixed to the lens holding member 2 using an adhesive.

As described above, the flange 52 projects radially outward from the outer peripheral surface of the end of the tubular part 12 in the direction facing the imaging sensor (Z2 direction). The coil 3 is disposed in the direction facing the subject (Z1 direction) of the flange 52. As shown in the lower drawing of FIG. 5, the flange 52 is formed with two notches 52k across the optical axis OA of the lens body. Extended parts 33, which are parts of a conductive wire (conductor) constituting the coil 3, pass through the notches 52k. Specifically, a left extended part 33L, which is a conductor portion in the direction of the winding start part of the coil 3, is passed through a left notch 52kL, which is one of the notches 52k, and a right extended part 33R, which is a conductor portion in the direction of the winding end part of the coil 3, is passed through a right notch 52kR, which is the other of the notches 52k.

As shown in the upper drawing of FIG. 5, the flange 52 includes two holding parts 72 as rectangular projecting protrusions protruding downward (Z2 direction) from the surface of the direction facing the imaging sensor (Z2 direction), six rounded projecting protruding parts 2p, and two rounded projecting abutting parts 2q. At least one of the protruding parts 2p and the abutting parts 2q may be a rectangular projecting shape.

As shown in the lower drawing of FIG. 5, the holding parts 72 include a left holding part 72L corresponding to the winding start direction of the coil 3 (winding part 13) and a right holding part 72R corresponding to the winding end direction of the coil 3 (winding part 13). The left extended part 33L is wound and held by the left holding part 72L, and the right extended part 33R is wound and held by the right holding part 72R.

As shown in the upper drawing of FIG. 5 and the upper drawing of FIG. 6, the protruding parts 2p include three protruding parts 2p corresponding to the lower left flat spring 26L and three protruding parts 2p corresponding to the lower right flat spring 26R. Inner portions 26i serving as movable supporting parts of the lower flat springs 26 are positioned and fixed to the protruding parts 2p. The protruding parts 2p are inserted into round holes 26k serving as through parts formed in the inner portions 26i (inner joint portions 26c) of the lower flat springs 26. The through parts may be holes other than round holes such as square holes or elliptical holes, or may be notches as long as they correspond to the shape of the protruding parts 2p.

Next, the driving part DM of the lens driving apparatus 101 will be described. As shown in the lower drawing of FIG. 6, the driving part DM includes the coil 3, the yoke 4, and four magnets 5 arranged so as to face each of the four corners of the yoke 4. The driving part DM generates driving force (thrust) by the current flowing in the coil 3 and the magnetic field generated by the magnets 5, and can move the lens holding member 2 up and down along the optical axis direction.

As shown in the lower drawing of FIG. 5, the coil 3 is formed by winding a conductor around the outer periphery of the lens holding member 2. The coil 3 includes a winding part 13 as a coil body which is formed by being wound in an octagonal ring, and the extended parts 33 which extend from the winding part 13 and are wound around the holding parts 72.

The extended parts 33 include a left extended part 33L connected to an end part (winding start part 13S) of the winding part 13 located on the inner peripheral direction of the winding part 13 in the winding start direction of the coil 3 (winding part 13), and a right extended part 33R connected to an end part (winding end part 13E) of the winding part 13 located on the outer peripheral direction of the winding part 13 in the winding end direction of the coil 3 (winding part 13).

Specifically, as shown in the lower drawing of FIG. 5, the left extended part 33L includes a wound part 33m wound around the left holding part 72L, a connecting part 33c extending facing the direction facing the imaging sensor (Z2 direction) surface of the flange 52, and an insertion part 33k inserted into the left notch 52kL and extending from the direction facing the imaging sensor (Z2 direction) of the flange 52 to the direction facing the subject (Z1 direction). Similarly, the right extended part 33R includes a wound part 33m wound around the right holding part 72R, a connecting part 33c extending facing the direction facing the imaging sensor (Z2 direction) surface of the flange 52, and an insertion part 33k inserted into the right notch 52kR and extending from the direction facing the imaging sensor (Z2 direction) of the flange 52 to the direction facing the subject (Z1 direction).

In the illustrated example, the left extended part 33L is wound around the left holding part 72L of the lens holding member 2 before the conductor constituting the coil 3 is wound around the outer periphery of the lens holding member 2 (coil supporting part 12j), that is, before the winding part 13 is formed. In the illustrated example, the left extended part 33L, which is a part of the conductor, is wound around the left holding part 72L for 4 turns. Thus, the wound part 33m is formed in the left holding part 72L, and a part of the left extended part 33L is held in the left holding part 72L. However, the left extended part 33L may be wound around the left holding part 72L after the conductor is wound around the outer periphery of the lens holding member 2, that is, after the winding part 13 is formed.

After the left extended part 33L is wound around the left holding part 72L, the conductor is wound around the outer periphery of the lens holding member 2. In this case, the conductor extending from the wound part 33m extends so as to face the bottom surface of the flange 52, and extends from an underside of the flange 52 to an upside of the flange 52 through the left notch 52kL. At this time, the portion facing the bottom surface of the flange 52 constitutes the connecting part 33c of the left extended part 33L, and the portion passing through the left notch 52kL constitutes the insertion part 33k of the left extended part 33L. A portion positioned between the wound part 33m and the insertion part 33k and not facing the flange 52 also constitutes the connecting part 33c of the left extended part 33L.

The winding part 13 of the coil 3 wound around the outer periphery of the lens holding member 2 is arranged at a position surrounding the periphery of the lens holding member 2, as shown in the lower drawing of FIG. 4. The winding part 13 is supported from the inside by the coil supporting part 12j (see the upper drawing of FIG. 4), and is fixed to the surface of the flange 52 facing the subject so as to be sandwiched between the regulation part 12h and the flange 52. Moreover, since the inner peripheral surface of the winding part 13 is evenly supported by the coil supporting part 12j in a balanced manner in all directions, the winding part 13 is held by the lens holding member 2 in a state where the central axis of the coil 3 and the central axis of the lens holding member 2 coincide. Therefore, the lens driving apparatus 101 is configured so that the optical axis OA of the lens body held by the lens holding member 2 easily coincides with the central axes of the lens holding member 2 and the coil 3.

When winding of the conductor to the outer periphery of the lens holding member 2 is completed, the right extended part 33R connected to the end of the winding part 13 is pulled out from a direction facing the subject of the flange 52 to a direction facing the imaging device of the flange 52 via the right notch 52kR, as shown in the lower drawing of FIG. 5. Specifically, the insertion part 33k passes through the right notch 52kR, and the wound part 33m is wound around the right holding part 72R of the lens holding member 2. In the illustrated example, the right extended part 33R is wound around the right holding part 72R for four turns. A portion of the right extended part 33R located between the insertion part 33k and the wound part 33m constitutes the connecting part 33c of the right extended part 33R.

Next, the yoke 4 included in the driving part DM will be described. In the present embodiment, the yoke 4 is manufactured by applying punching, drawing, and the like to a plate made of a soft magnetic material such as iron. Specifically, as shown in FIG. 1, the yoke 4 has a box-shaped outer shape defining a housing part 4s. As shown in FIG. 2, the yoke 4 has a rectangular tubular outer wall part 4A and a flat annular upper surface part 4B provided so as to be continuous with the upper end (end of Z1 direction) of the outer wall part 4A. As shown in the lower drawing of FIG. 6, the yoke 4 is thus configured to accommodate the magnets 5 in the housing part 4s so as to be interposed between the outer wall part 4A and the coil 3, and as shown in the upper drawing of FIG. 3, it is coupled to the base member 18 to constitute the housing HS together with the base member 18. However, the yoke 4 may be replaced with a cover member formed of a non-magnetic material such as austenitic stainless steel.

Next, the magnets 5 constituting the driving part DM will be described. As shown in FIG. 2, the magnet 5 has a square pillar shape with a trapezoidal bottom. As shown in the lower drawing of FIG. 6, the four magnets 5 are positioned outside the coil 3 and are arranged so as to face each of the four corners of the rectangular tubular outer wall part 4A constituting the yoke 4. The magnets 5 are fixed to the inner surface of the yoke 4 by an adhesive. The magnets 5 are arranged so that, for example, inner surfaces (surfaces facing the optical axis OA) are N poles and outer surfaces are S poles, or the inner surface are S poles and the outer surfaces are N poles.

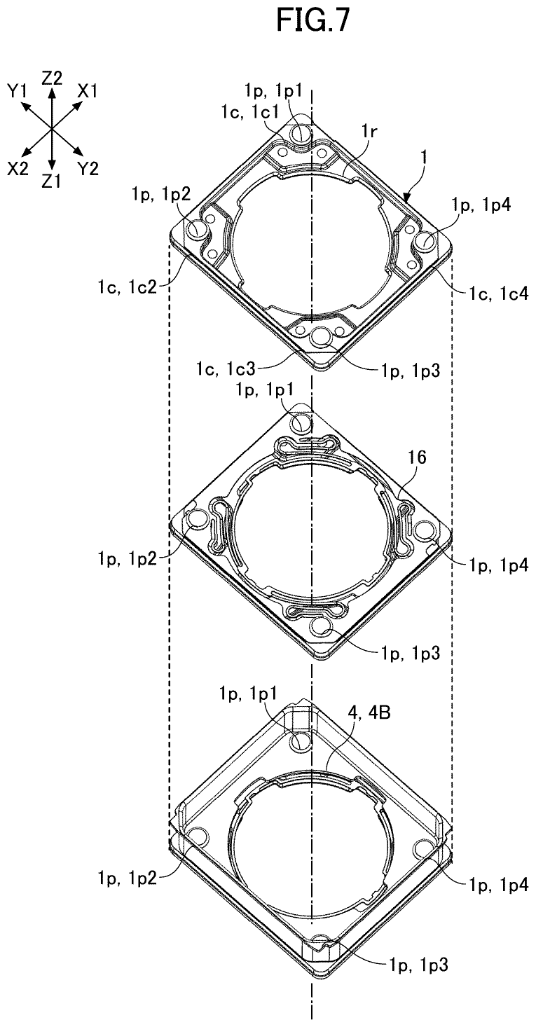

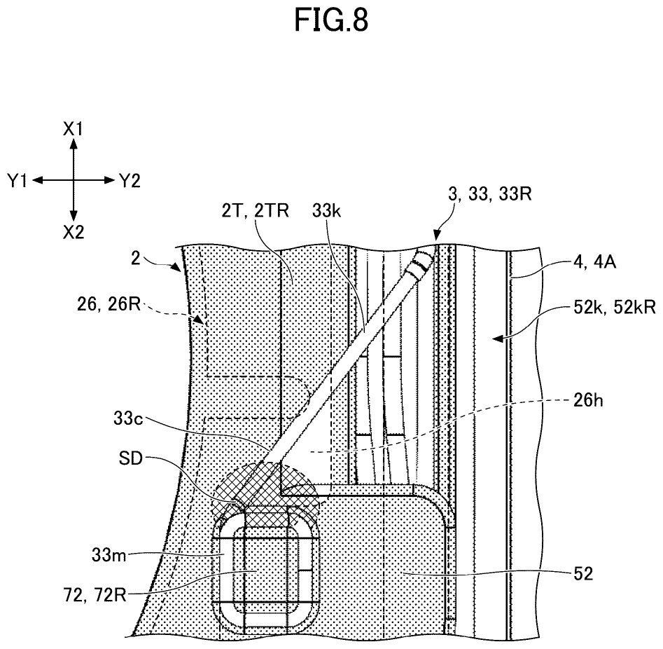

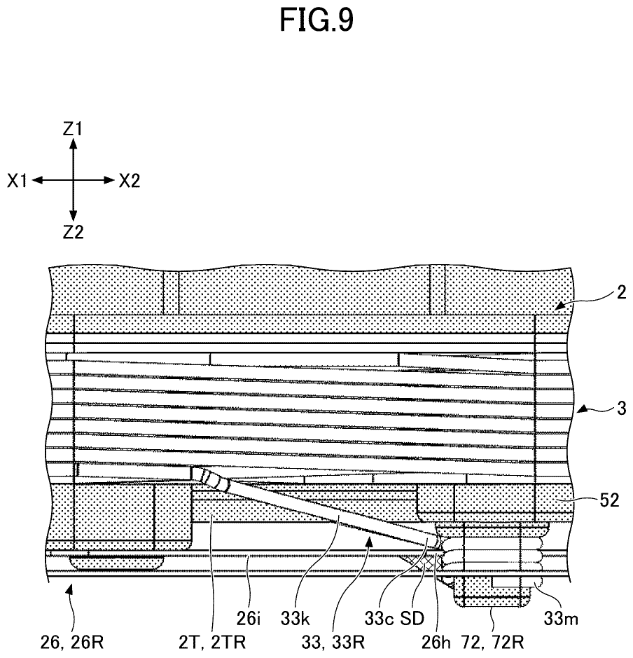

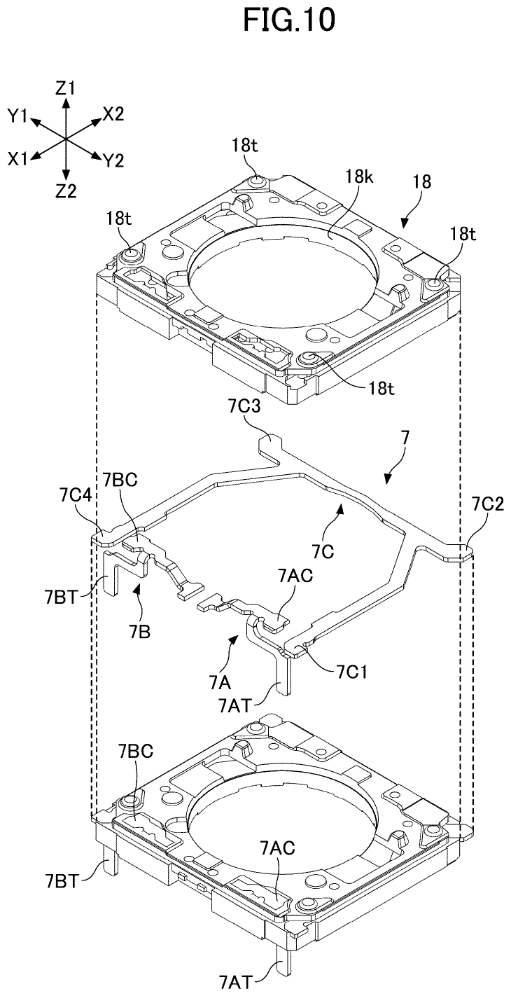

Next, the flat springs 6 and the fixed member FB will be described. FIG. 7 is a view explaining an example of the connection structure of the three members (flat spring holding member 1, yoke 4, and upper flat spring 16). Specifically, the upper drawing of FIG. 7 is a perspective view from below of the flat spring holding member 1. The center drawing of FIG. 7 is a perspective view from below of the flat spring holding member 1 and the upper flat spring 16. The lower drawing of FIG. 7 is a perspective view from below of the flat spring holding member 1, the yoke 4, and the upper flat spring 16. FIGS. 8 and 9 illustrate an example of the connection structure between the lower right flat spring 26R and the coil 3 (the right extended part 33R). Specifically, FIG. 8 is an enlarged view of the range R1 shown in the upper drawing of FIG. 6, and FIG. 9 is an enlarged view of the lower right flat spring 26R, the coil 3, and the lens holding member 2 when the range R1 is viewed from the Y2 direction. In FIGS. 8 and 9, the solder SD connecting the coil 3 and the lower right flat spring 26R is shown by cross-hatching. In FIG. 8, the lower right flat spring 26R is shown by a broken line, and in FIG. 9, the yoke 4 is not shown. FIG. 10 is a view for explaining the base member 18 as the fixed member FB. Specifically, the upper drawing of FIG. 10 is a perspective view from above of the base member 18, the center drawing of FIG. 10 is a perspective view from above of the metal members 7, and the lower drawing of FIG. 10 is a perspective view from above of the base member 18 in which the metal members 7 are embedded.

In the present embodiment, the flat springs 6 are made of a metal plate mainly made of copper alloy. The flat springs 6 include an upper flat spring 16 arranged between the lens holding member 2 and the yoke 4, as shown in the upper drawing of FIG. 3, and lower flat springs 26 arranged between the lens holding member 2 and the base member 18, as shown in the upper drawing of FIG. 6. With the lens holding member 2 and the flat springs 6 (upper flat spring 16, lower left flat spring 26L, and lower right flat spring 26R) connected, the flat spring 6 supports the lens holding member 2 so that the lens holding member 2 can move in the optical axis direction (Z-axis direction). The lower flat springs 26 (the lower left flat spring 26L and the lower right flat spring 26R) also function as power supply members for supplying current to the coil 3. Therefore, the lower left flat spring 26L is electrically connected to one end of the coil 3, and the lower right flat spring 26R is electrically connected to the other end of the coil 3.

As shown in the upper drawing of FIG. 3, the upper flat spring 16 has a substantially rectangular shape in top view and includes an inner portion 16i as a movable supporting part fixed to the lens holding member 2, an outer portion 16e as a fixed supporting part fixed to the fixed member FB (flat spring holding member 1 and yoke 4), and four elastic arms 16g located between the inner portion 16i and the outer portion 16e. Specifically, the inner portion 16i is provided in an annular shape so as to surround the optical axis OA. The outer portion 16e has four corner portions 16b and four piers 16r connecting two adjacent portions of the four corner portions 16b.

In the illustrated example, the upper flat spring 16 is formed so as to be substantially twofold symmetrical, and is fixed to the lens holding member 2 by the inner portion 16i, and fixed to the flat spring holding member 1 and yoke 4 by the outer portion 16e. Therefore, the upper flat spring 16 can support the lens holding member 2 in a balanced manner.

When the upper flat spring 16 is attached to the lens driving apparatus 101, as shown in the upper drawing of FIG. 3, the inner portion 16i is placed on the pedestal part 12d of the lens holding member 2 (see the center drawing of FIG. 3). Then, the inner portion 16i and the pedestal part 12d are joined by an adhesive AD, and the inner portion 16i is fixed to the lens holding member 2. The outer portion 16e is held between the flat spring holding member 1 and the upper surface part 4B of the yoke 4 and fixed with the adhesive.

The flat spring holding member 1 is configured to hold the upper flat spring 16 in the direction facing the subject (Z1 direction) of the yoke 4. Specifically, as shown in the upper drawing of FIG. 7, the flat spring holding member 1 has a substantially rectangular annular shape and has four corner parts 1c (first corner part 1c1 to fourth corner part 1c4), projections 1p (first projection 1p1 to fourth projection 1p4) projecting downward (Z2 direction) from each of the four corner parts 1c, and a recess 1r formed inside the bottom surface (surface in Z2 direction).

The projections 1p are inserted into round holes 16k (see the upper drawing of FIG. 3) as through parts formed in the corner portion 16b of the upper flat spring 16, and also into round holes 4k (see the center drawing of FIG. 3) as through parts formed in each of the four corner parts of the upper surface part 4B constituting the yoke 4.

More specifically, as shown in the upper drawing of FIG. 7, the projections 1p in the flat spring holding member 1 include first projection 1p1 to fourth projection 1p4. The round holes 4k formed in the yoke 4 include first round hole 4k1 to fourth round hole 4k4, as shown in the center drawing of FIG. 3. The round holes 16k formed in the upper flat spring 16 include first round hole 16k1 to fourth round hole 16k4, as shown in the upper drawing of FIG. 3. Then, as shown in the center drawing of FIG. 7, the first projection 1p1 is inserted into the first round hole 16k1 formed in the upper flat spring 16, the second projection 1p2 is inserted into the second round hole 16k2, the third projection 1p3 is inserted into the third round hole 16k3, and the fourth projection 1p4 is inserted into the fourth round hole 16k4. Furthermore, as shown in the lower drawing of FIG. 7, the first projection 1p1 is inserted into the first round hole 4k1 formed in the upper surface part 4B of the yoke 4, the second projection 1p2 is inserted into the second round hole 4k2, the third projection 1p3 is inserted into the third round hole 4k3, and the fourth projection 1p4 is inserted into the fourth round hole 4k4.

Thereafter, the projections 1p are thermally caulked. In FIG. 7, the projections 1p are shown in a state where the tips of the projections 1p are deformed after being thermally caulked. The projections 1p may also be cold-caulked.

Thus, the outer portion 16e of the upper flat spring 16 is interposed and fixed between the flat spring holding member 1 and the upper surface part 4B of the yoke 4 and is fixed. In the illustrated example, the adhesive is applied between the corner part 1c of the flat spring holding member 1 and the corner portion 16b of the outer portion 16e, and between the corner portion of the upper surface part 4B and the corner portion 16b of the outer portion 16e.

The recess 1r of the flat spring holding member 1 is configured to allow elastic deformation of the elastic arm 16g constituting the upper flat spring 16. In the illustrated example, when no current flows through the coil 3, the lens holding member 2 does not float upwards, but is biased toward the direction facing the imaging sensor (Z2 direction) by the flat spring 6, and contacts the upper surface (surface facing the Z1 direction) of the base member 18 via the abutting part 2q. When current flows through the coil 3, the lens holding member 2 is moved toward the direction facing the subject (Z1 direction) by electromagnetic force, and is held in the air and spaced from the base member 18. At this time, the portion of the elastic arm 16g of the upper flat spring 16 that contacts the inner portion 16i is displaced upward (Z1 direction). The recess 1r of the flat spring holding member 1 is formed to allow this displacement.

As shown in the upper drawing of FIG. 3, the upper end of the lens holding member 2 protrudes upward (Z1 direction) from the upper surface part 4B of the yoke 4 even when current does not flow through the coil 3. Therefore, the recess 1r of the flat spring holding member 1 is formed to allow displacement of the elastic arm 16g and further protrusion of the lens holding member 2 when current flows through the coil 3.

As shown in the upper drawing of FIG. 6, the lower left flat spring 26L and the lower right flat spring 26R are formed to be substantially symmetrical to each other, and the shapes of their inner portions (directions facing the optical axis OA) are formed to be substantially semicircular. Each of the lower left flat spring 26L and the lower right flat spring 26R includes an inner portion 26i as a movable supporting part fixed to the lens holding member 2, an outer portion 26e as a fixed supporting part fixed to the fixed member FB (base member 18), and two elastic arms 26g positioned between the inner portion 26i and the outer portion 26e.

Each inner portion 26i of the lower left flat spring 26L and the lower right flat spring 26R includes, as shown in the upper drawing of FIG. 6, three inner joint portions 26c joined to the lens holding member 2 and a connecting plate part 26h facing the extended part 33 of the coil 3.

When the lower left flat spring 26L and the lower right flat spring 26R are attached to the lens holding member 2, each of the six protruding parts 2p of the lens holding member 2 shown in the upper drawing of FIG. 5 is inserted into a round hole 26k as a through part provided in each inner joint portion 26c of the lower left flat spring 26L and the lower right flat spring 26R shown in the upper drawing of FIG. 6. The round hole 26k as a through part may be a notch. Thus, each inner portion 26i of the lower left flat spring 26L and the lower right flat spring 26R is positioned and fixed to the lens holding member 2. The lower left flat spring 26L and the lower right flat spring 26R are fixed to the lens holding member 2, for example, by applying thermal caulking or cold caulking to the protruding part 2p of the lens holding member 2.

As shown in FIGS. 8 and 9, the connecting plate part 26h of the inner portion 26i constituting the lower right flat spring 26R faces the surface of the lens holding member 2 in the direction facing the imaging sensor (Z2 direction) when the lower right flat spring 26R is attached to the lens holding member 2. That is, the surface in the direction facing the subject (Z1 direction) of the connecting plate part 26h faces the surface in the direction facing the imaging sensor (Z2 direction) of the flange 52 constituting the lens holding member 2. The connecting part 33c of the right extended part 33R constituting the coil 3 extends between the surface in the direction facing the subject (Z1 direction) of the inner portion 26i of the lower right flat spring 26R and the surface in the direction facing the imaging sensor (Z2 direction) of the flange 52 of the lens holding member 2, as shown in FIG. 9.

When the lower right flat spring 26R is attached to the lens holding member 2, as shown in FIG. 9, the right holding part 72R projects downward (Z2 direction) from the inner portion 26i so that the tip thereof is positioned closer to the direction facing the imaging sensor (Z2 direction) than the inner portion 26i of the lower right flat spring 26R. A part of the wound part 33m is also wound around the right holding part 72R so that it is positioned closer to the direction facing the imaging sensor (Z2 direction) than the inner portion 26i.

The lower right flat spring 26R and the right extended part 33R (wound part 33m) of the coil 3 are electrically and mechanically connected by solder SD. Specifically, as shown in the upper drawing of FIG. 6, the lower right flat spring 26R is attached to the lens holding member 2 so that the round hole 26k formed in the inner joint portion 26c and the protruding part 2p of the lens holding member 2 are fitted. The protruding part 2p of the lens holding member 2 is thermally caulked, and the solder paste applied to the connecting plate part 26h is heated by laser light. However, the lower right flat spring 26R and the right extended part 33R of the coil 3 may be electrically and mechanically connected by a conductive adhesive in which conductive fillers such as silver particles are dispersed in synthetic resin. The above description referring to FIGS. 8 and 9 also applies to the connection between the lower left flat spring 26L, the lens holding member 2, and the coil 3.

As shown in the upper drawing of FIG. 6, the outer portion 26e of the lower left flat spring 26L includes two outer joint portions 26d joined to the base member 18. Similarly, the outer portion 26e of the lower right flat spring 26R includes two outer joint portions 26d joined to the base member 18.

The base member 18 is manufactured by injection molding using, for example, a synthetic resin such as liquid crystal polymer. In the present embodiment, as shown in FIG. 10, the base member 18 is a member having a substantially rectangular plate-like outer shape, and a circular opening 18k is formed in the center. Further, four protruding parts 18t protruding upward are provided on the surface of the base member 18 in the direction facing the subject (Z1 direction). The protruding parts 18t are inserted into and fitted into the through-holes 26t (see the upper drawing of FIG. 6) provided in the outer joint portions 26d of the lower left flat spring 26L and the lower right flat spring 26R, respectively. At this time, the protruding parts 18t are thermally caulked and fixed to the outer joint portions 26d. In FIG. 10, the protruding parts 18t are shown in a state in which their tips are deformed after being subjected to thermal caulking. The protruding parts 18t may also be fixed to the outer joint portion 26d after being subjected to cold caulking.

As shown in FIG. 10, metal members 7 formed of metal plates containing a material such as copper, iron, or an alloy whose main component is copper or iron, are inserted and embedded in the base member 18.

The metal members 7 include a first metal member 7A to a third metal member 7C. The first metal member 7A has a connecting part 7AC exposed from the upper surface (surface facing the Z1 direction) of the base member 18, and the second metal member 7B has a connecting part 7BC exposed from the upper surface (surface facing the Z1 direction) of the base member 18. The surface of the connecting part 7AC and the surface of the connecting part 7BC are located on the same plane.

The connecting part 7AC is connected to the outer joint portion 26d of the lower right flat spring 26R via a conductive joining material while facing the through hole 26dt (see the upper drawing of FIG. 6) formed in the outer joint portion 26d of the lower right flat spring 26R. The conductive bonding material is, for example, solder or conductive adhesive. In the present embodiment, the conductive bonding material is a conductive adhesive.

Similarly, the connecting part 7BC is connected to the outer joint portion 26d of the lower left flat spring 26L via the conductive bonding material while facing the through hole 26dt (see the upper drawing of FIG. 6) formed in the outer joint portion 26d of the lower left flat spring 26L.

The first metal member 7A has a terminal part 7AT projecting downward from the bottom surface (surface facing Z2 direction) of the base member 18, and the second metal member 7B has a terminal part 7BT projecting downward from the bottom surface (surface facing the Z2 direction) of the base member 18.

The third metal member 7C has end parts 7C1 to 7C4 protruding outward in the direction perpendicular to the optical axis direction from the corner part of the base member 18. Each of the end parts 7C1 to 7C4 is configured to contact the lower end parts of the four corners of the yoke 4 as shown in FIG. 1.

The base member 18 is fixed to the yoke 4 by welding each of the end parts 7C1 to 7C4 and the lower end parts of the four corners of the yoke 4 after the inner surface of the outer wall part 4A of the yoke 4 and the outer peripheral lateral surface of the base member 18 are combined and positioned. The yoke 4 and the base member 18 may be fixed at least partially by adhesive.

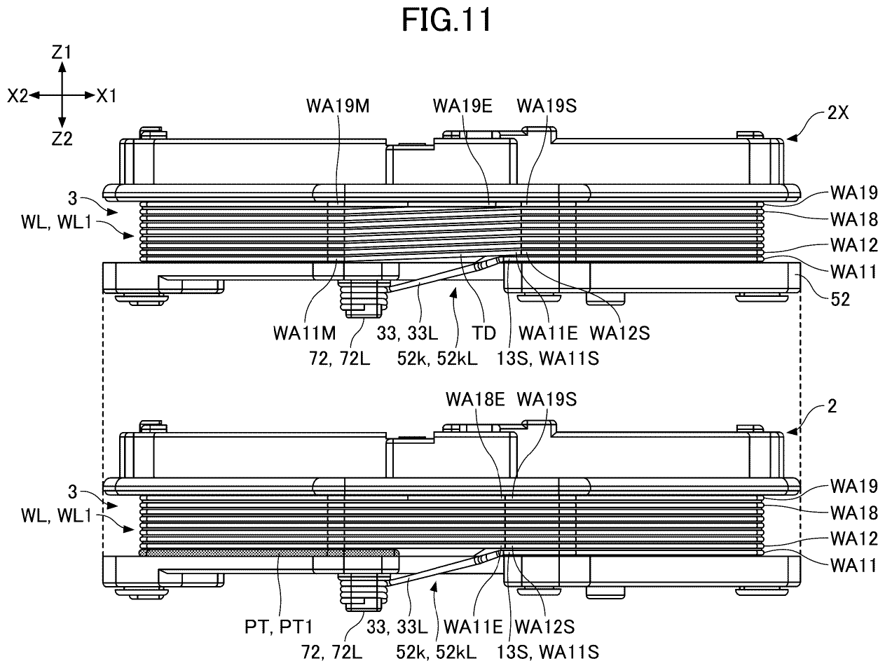

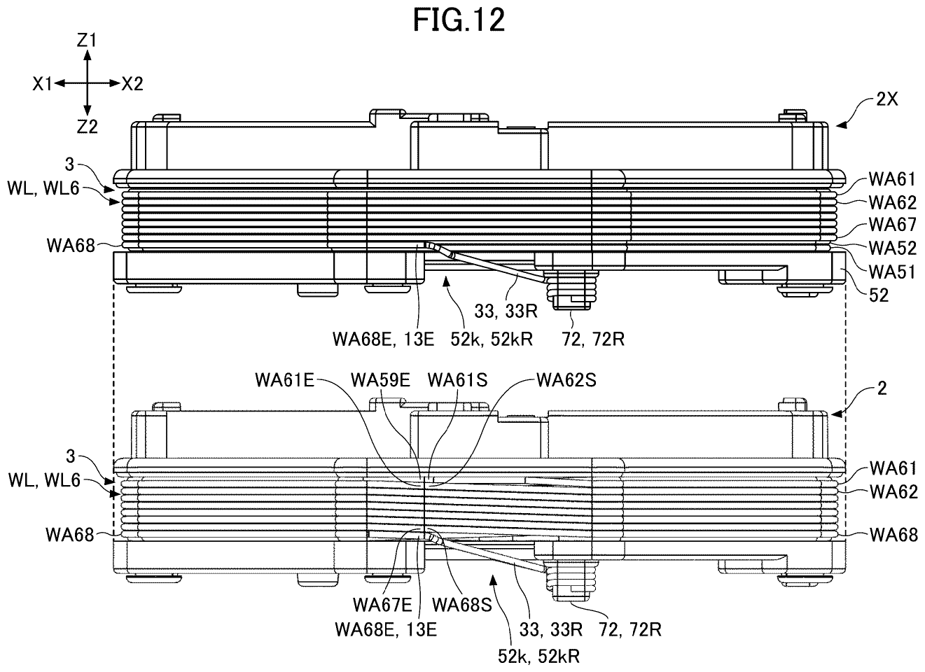

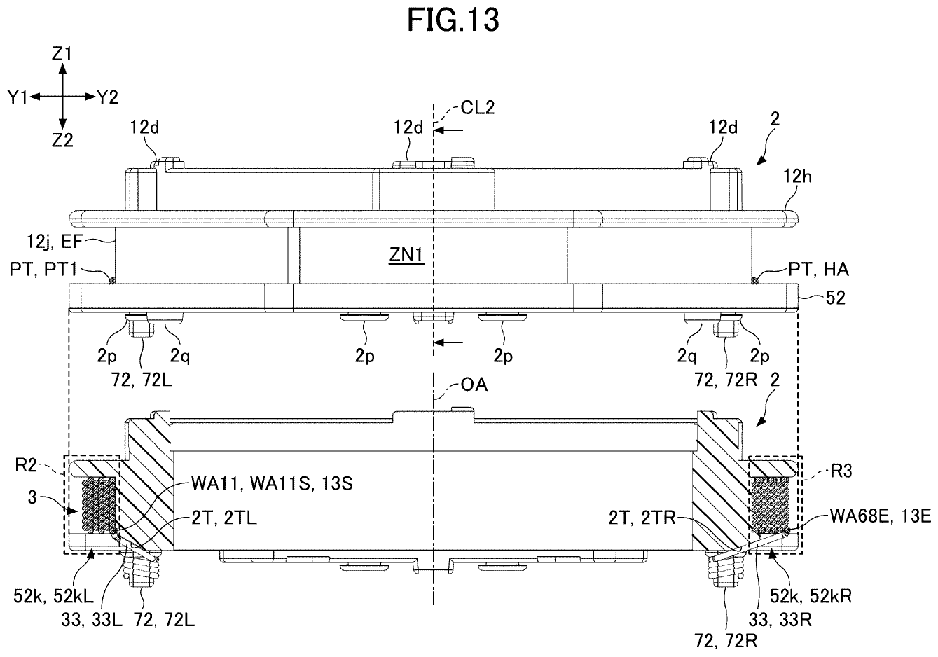

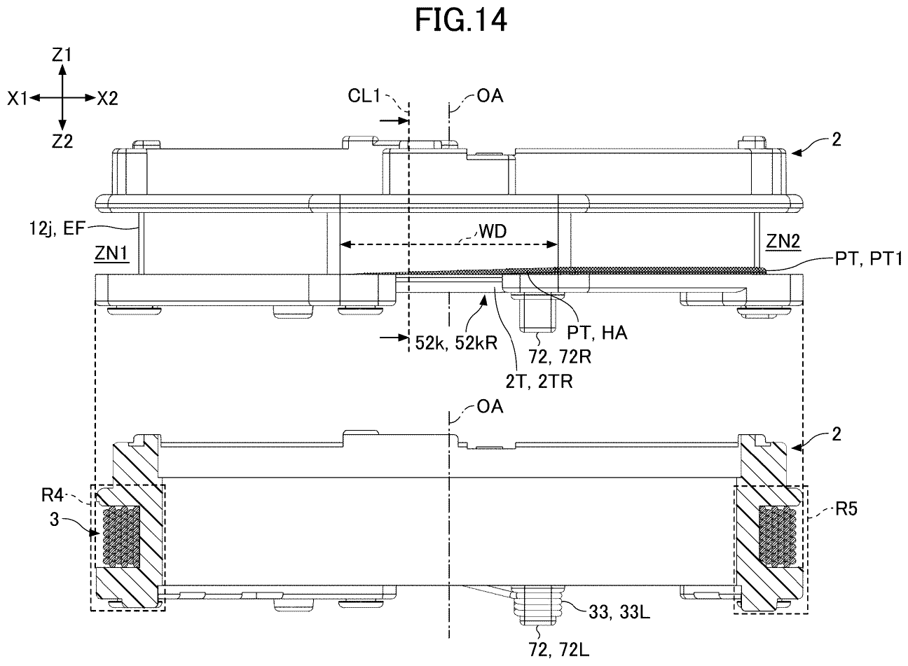

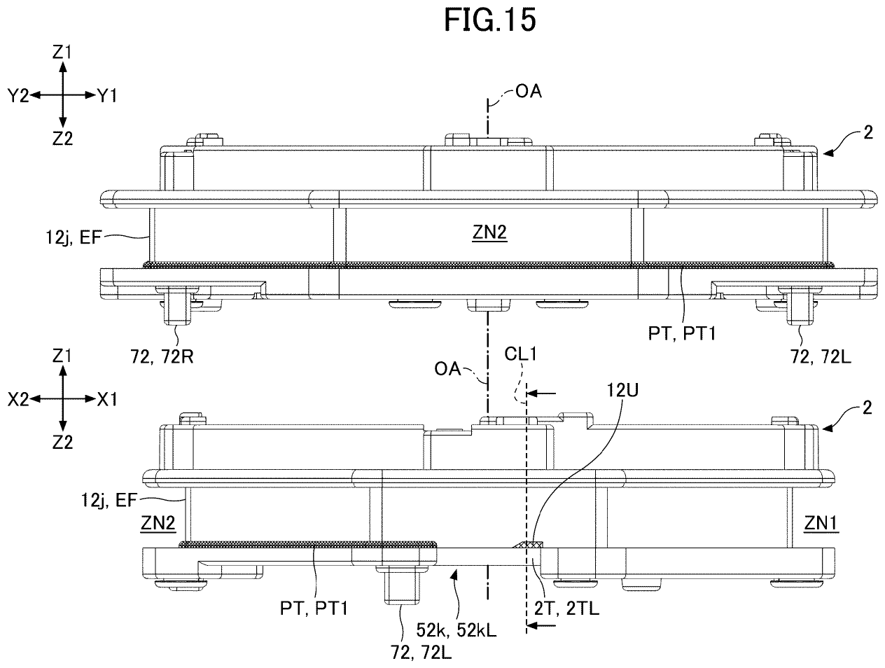

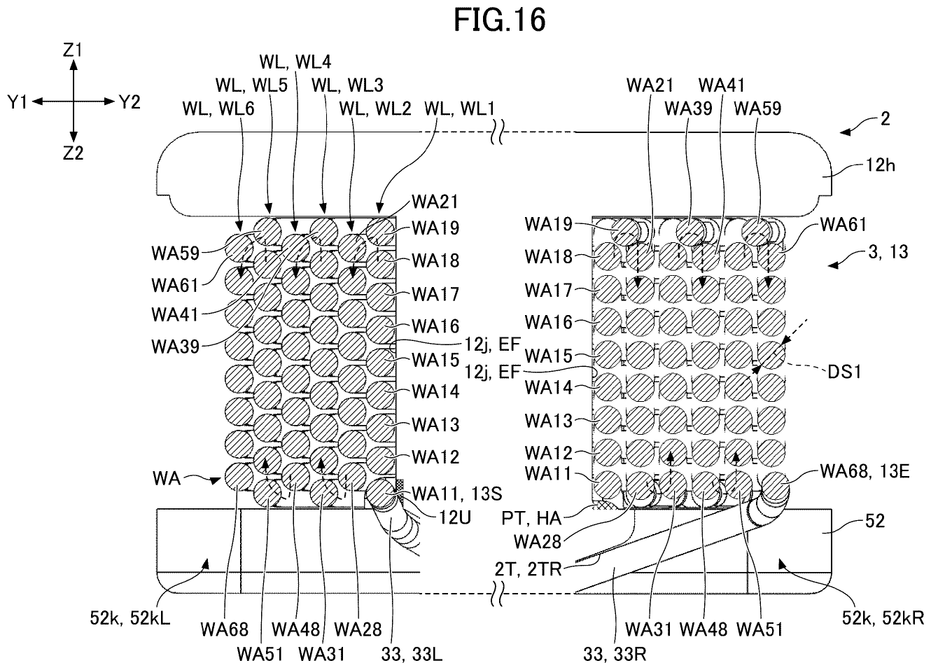

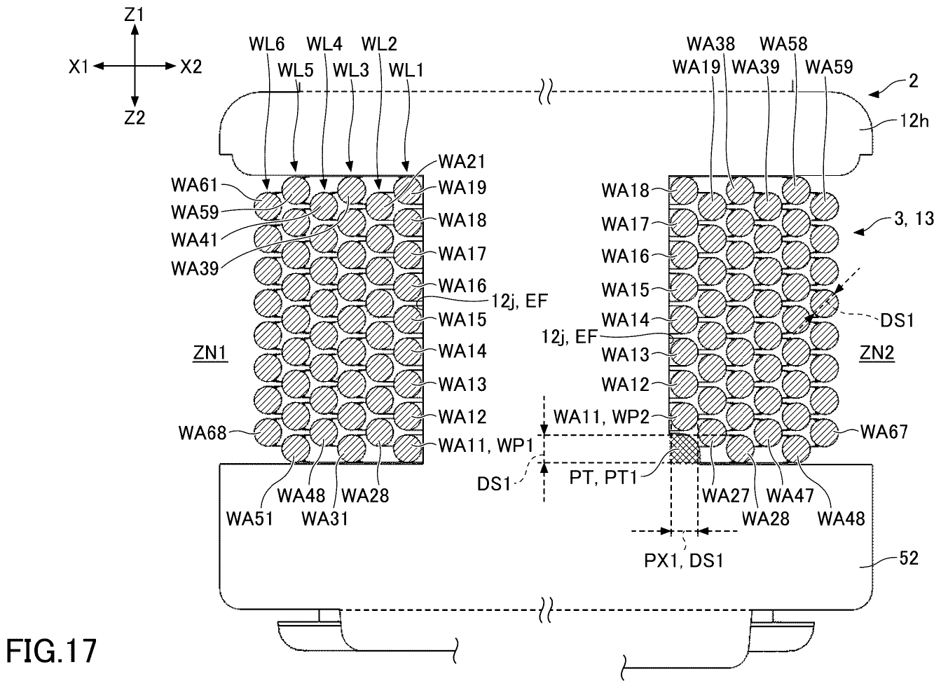

Next, the positional relation between the lens holding member 2 and the coil 3 will be described with reference to FIGS. 11 to 17. FIGS. 11 to 15 are drawings of the lens holding member 2 viewed from the direction perpendicular to the optical axis direction. Specifically, the upper drawing of FIG. 11 is a left side view of the lens holding member 2X as a comparative example, and the lower drawing of FIG. 11 is a left side view of the lens holding member 2. FIG. 11 shows a state when only the innermost layer (first layer WL1) of the six winding layers WL constituting the winding part 13 of the coil 3 is wound. The upper drawing of FIG. 12 is a right side view of the lens holding member 2X as a comparative example, and the lower drawing of FIG. 12 is a right side view of the lens holding member 2. FIG. 12 shows a state when all of the winding parts 13 of the coil 3 are wound. The upper drawing of FIG. 13 is a front view of the lens holding member 2. The lower drawing of FIG. 13 is a cross-sectional view of the lens holding member 2 wound with the coil 3, and shows the cross sections of the lens holding member 2 and the coil 3 viewed from the X1 direction in the virtual plane parallel to the YZ plane including the cutting line CL1 in the lower drawing of FIG. 4. The upper drawing of FIG. 14 is a right side view of the lens holding member 2. The lower drawing of FIG. 14 is a cross-sectional view of the lens holding member 2 wound with the coil 3, and shows the cross sections of the lens holding member 2 and the coil 3 viewed from the Y2 direction in the virtual plane parallel to the XZ plane including the cutting line CL2 in the lower drawing of FIG. 4. The upper drawing of FIG. 15 is a rear view of the lens holding member 2, and the lower drawing of FIG. 15 is a left side view of the lens holding member 2. FIGS. 16 and 17 are cross-sectional views of the lens holding member 2 and the coil 3. Specifically, a left drawing of FIG. 16 is an enlarged view of the range R2 surrounded by the broken line in the lower drawing of FIG. 13, and a right drawing of FIG. 16 is an enlarged view of the range R3 surrounded by the broken line in the lower drawing of FIG. 13. A left drawing of FIG. 17 is an enlarged view of the range R4 surrounded by the broken line in the lower drawing of FIG. 14, and the right drawing of FIG. 17 is an enlarged view of the range R5 surrounded by the broken line in the lower drawing of FIG. 14. In FIGS. 16 and 17, a cross-sectional pattern (diagonal line pattern) is added only to the cross section of the wire constituting the coil 3.

The conductor (wire) constituting the coil 3 has a conductive metal wire and an insulating coating layer covering the metal wire. The coating layer has a two-layer structure having an insulating layer covering the metal wire and a fusion layer arranged around the insulating layer. In FIGS. 11 to 17, the illustration of the coating layer is omitted for the sake of clarity. When the coil 3 is wound around the outer periphery of the lens holding member 2, the two wire annular portions WA adjacent to each other are thermally fused to each other.

In the upper drawing of FIG. 11, only the innermost layer (first layer WL1) of the six winding layers WL constituting the winding part 13 of the coil 3 is wound around the lens holding member 2X as a comparative example. The first layer WL1 includes a nine-turn wire annular portion WA (first wire annular portion WA11 to ninth wire annular portion WA19).

The first wire annular portion WA11 extends parallel to the XY plane from the starting point WA11S, which is also the winding start part 13S of the winding part 13, to the intermediate point WA11M, and then extends obliquely upward to the ending point WA11E, and connects to the starting point WA12S of the second wire annular portion WA12 at the ending point WA11E. In the upper drawing of FIG. 11, the obliquely extended part of the first wire annular portion WA11 is referred to as the inclined portion TD. The same applies to the second wire annular portion WA12 to the eighth wire annular portion WA18.

The ninth wire annular portion WA19 extends parallel to the XY plane from the starting point WA19S to the intermediate point WA19M, then runs on the inclined portion TD of the eighth wire annular portion WA18 and is stacked on the outside of the inclined portion TD of the eighth wire annular portion WA18, and connects to the starting point of the first wire annular portion WA21 of the second layer WL2 (not shown in the upper drawing of FIG. 11) at the ending point WA19E.

Since the first layer WL1 is wound around the outer peripheral surface of the lens holding member 2X in this manner, in the lens holding member 2X, the eighth wire annular portion WA68, which is the last wire annular portion WA in the outermost layer (sixth layer WL6), is shorter by half a circumference than the other wire annular portions WA (first wire annular portion WA61 to seventh wire annular portion WA67) in the outermost layer (sixth layer WL6), as shown in the upper drawing of FIG. 12. Specifically, the eighth wire annular portion WA68 is pulled out from the surface facing the object (Z1 direction) of the flange 52 to the direction facing the imaging sensor (Z2 direction) of the flange 52 through the right notch 52kR when the ending point WA68E, which is also the winding end part 13E of the winding part 13, reaches the right notch 52kR, as shown in the upper drawing of FIG. 12.

In this configuration, the winding number (the number of wire annular portions WA) of the sixth layer WL6, which is the outermost layer, decreases by half a circumference of the eighth wire annular portion WA68. When the number of wire annular portions WA in the outermost layer closest to the magnet 5 decreases, the thrust generated by the driving part DM decreases. In addition, the thrust generated by the driving part DM differs between the X1 direction (direction where the eighth wire annular portion WA68 of the half circumference exists) and the X2 direction (the direction where the annular portion of the wire annular portion of the half circumference does not exist), resulting in an imbalance.

Therefore, as shown in the lower drawing of FIG. 11, the lens holding member 2 according to the embodiment of the present disclosure has a protrusion PT corresponding to a half circumference of the wire on the outer peripheral surface EF of the coil supporting part 12j, which is a portion on which the wire is wound, so that the number of turns (the number of wire annular portions WA) of the outermost layer does not decrease. In FIGS. 11, 13, 14, and 15, a dot pattern is applied to the surface of the protrusion PT for clarity. In FIGS. 16 and 17, a cross pattern is applied to the cross section of the protrusion PT for clarity.

Specifically, in the lower drawing of FIG. 11, as in the case of the lens holding member 2X as a comparative example, only the innermost layer (first layer WL1) of the six winding layers WL constituting the winding part 13 of the coil 3 is wound on the lens holding member 2. The first layer WL1 includes the nine-turn wire annular portion WA (first wire annular portion WA11 to ninth wire annular portion WA19).

The first wire annular portion WA11 extends parallel to the XY plane for approximately half a circumference from the starting point WA11S, which is also the winding start part 13S of the winding part 13, then rides over a height adjusting part HA (see the upper drawing of FIG. 14) of the protrusion PT and is stacked on top of the height adjusting part HA, then extends along the first protrusion PT1 of the protrusion PT extending parallel to the XY plane, and connects to the starting point WA12S of the second wire annular portion WA12 at the ending point WA11E. The same applies to the second wire annular portion WA12 to the ninth wire annular portion WA19.

The left extended part 33L wound around the left holding part 72L extends along the inclined surface 2T (left inclined surface 2TL) of the lens holding member 2 and connects to the starting point WA11S of the first wire annular portion WA11 of the first layer WL1, as shown in the lower drawing of FIG. 13. The right extended part 33R wound around the right holding part 72R extends along the inclined surface 2T (right inclined surface 2TR) of the lens holding member 2 and connects to the ending point WA68E of the eighth wire annular portion WA68 of the sixth layer WL6, as shown in the lower drawing of FIG. 13.

As shown in the lower drawing of FIG. 15, a recess 12U is formed in the coil supporting part 12j corresponding to the winding start part 13S of the winding part 13. In FIG. 15, the recess 12U is provided with a cross pattern for clarity. As shown in FIG. 16, the recess 12U has a structure for aligning a radial position of the first wire annular portion WA11 in the first layer WL1 with the radial position of the other wire annular portions WA (second wire annular portion WA12 to ninth wire annular portion WA19) in the first layer WL1.

Since the first layer WL1 is wound around the outer peripheral surface EF of the coil supporting part 12j in this manner, in the lens holding member 2, the eighth wire annular portion WA68, which is the last wire annular portion WA in the outermost layer (sixth layer WL6), has the same length as the other wire annular portions WA (the first wire annular portion WA61 to the seventh wire annular portion WA67) in the outermost layer (sixth layer WL6), as shown in the lower drawing of FIG. 12. Specifically, the eighth wire annular portion WA68 is pulled out from the direction facing the object (Z1 direction) of the flange 52 to the direction facing the imaging sensor (Z2 direction) of the flange 52 via the right notch 52kR when the starting point WA68S and the ending point WA68E are both located above the right notch 52kR and the ending point WA68E reaches the right notch 52kR.

In such a configuration, the number of turns (number of wire annular portions WA) of the outermost layer, the sixth layer WL6, does not decrease by half the circumference of the eighth wire annular portion WA68 as in the case of the lens holding member 2X. Therefore, it is possible to suppress decrease in the thrust generated by the driving part DM, and to prevent imbalance caused by the difference in the thrust generated by the driving part DM between the X1 direction and the X2 direction.

More specifically, the winding part 13 of the coil 3 has six winding layers WL, as shown in FIG. 16. The six winding layers WL include a first layer WL1 to a sixth layer WL6. The first layer WL1 includes the nine-turn wire annular portion WA (first wire annular portion WA11 to ninth wire annular portion WA19), the second layer WL2 includes an eight-turn wire annular portion WA (first wire annular portion WA21 to eighth wire annular portion WA28), the third layer WL3 includes a nine-turn wire annular portion WA (first wire annular portion WA31 to ninth wire annular portion WA39), the fourth layer WL4 includes an eight-turn wire annular portion WA (first wire annular portion WA41 to eighth wire annular portion WA48), the fifth layer WL5 includes a nine-turn wire annular portion WA (first wire annular portion WA51 to ninth wire annular portion WA59), and the sixth layer WL6 includes an eight-turn wire annular portion WA (first wire annular portion WA61 to eighth wire annular portion WA68). That is, the winding part 13 includes a 51-turn wire annular portion WA.

The protrusion PT includes a height adjusting part HA and a first protrusion PT1. As shown in the upper drawing of FIG. 14, the height adjusting part HA is a portion which gradually rises in the Z-axis direction over the width WD along the X-axis direction. The first protrusion PT1 extends parallel to the XY plane and does not change in height in the Z-axis direction. In the illustrated example, the first protrusion PT1 is higher than the upper surface of the flange 52 by the thickness DS1 (see FIG. 17), which is the diameter of the wire.

This configuration can suppress the decrease in thrust generated by the driving part DM by avoiding the number of the wire annular portions WA in the outermost layer closest to the magnet 5 decreasing by half a circumference.

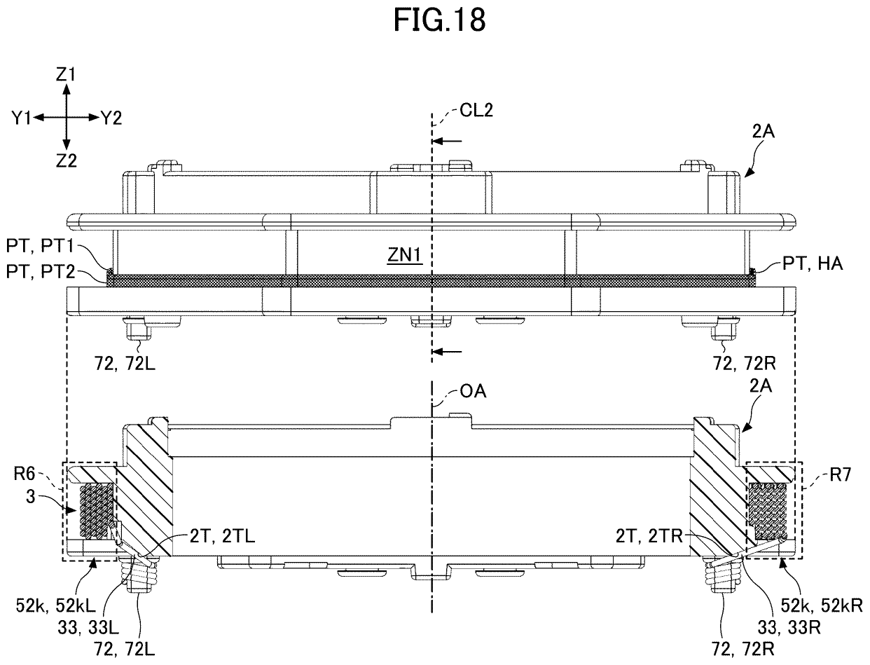

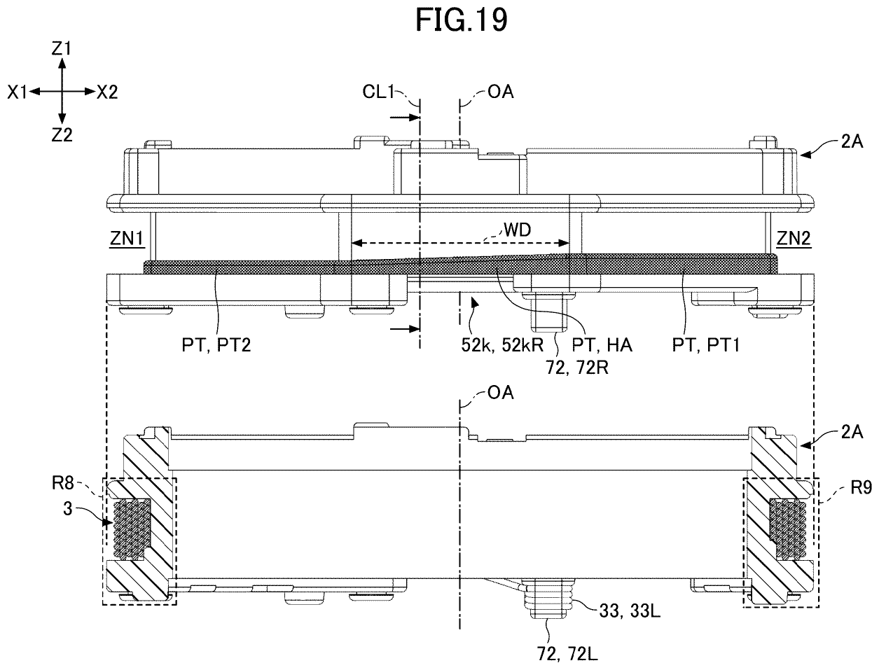

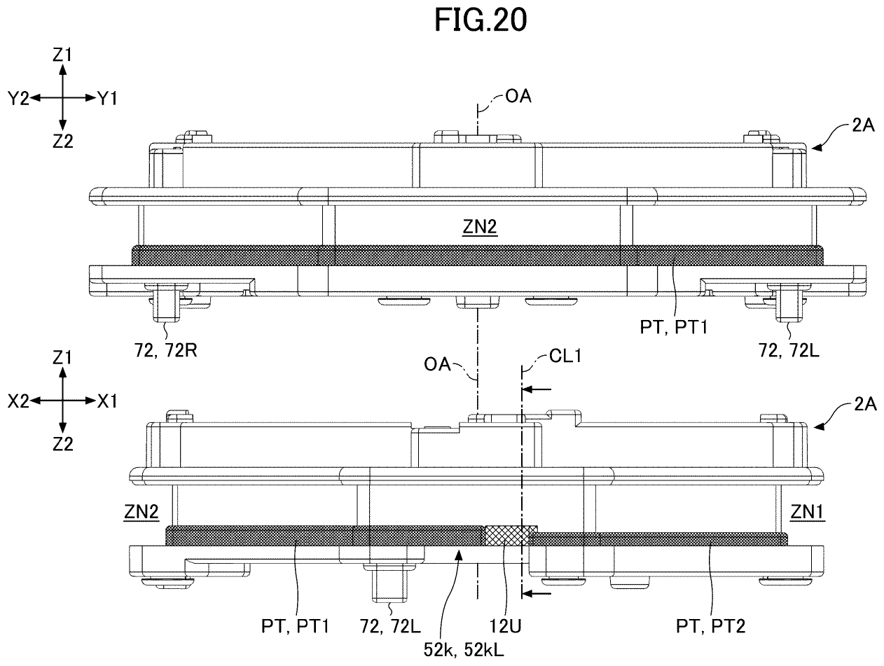

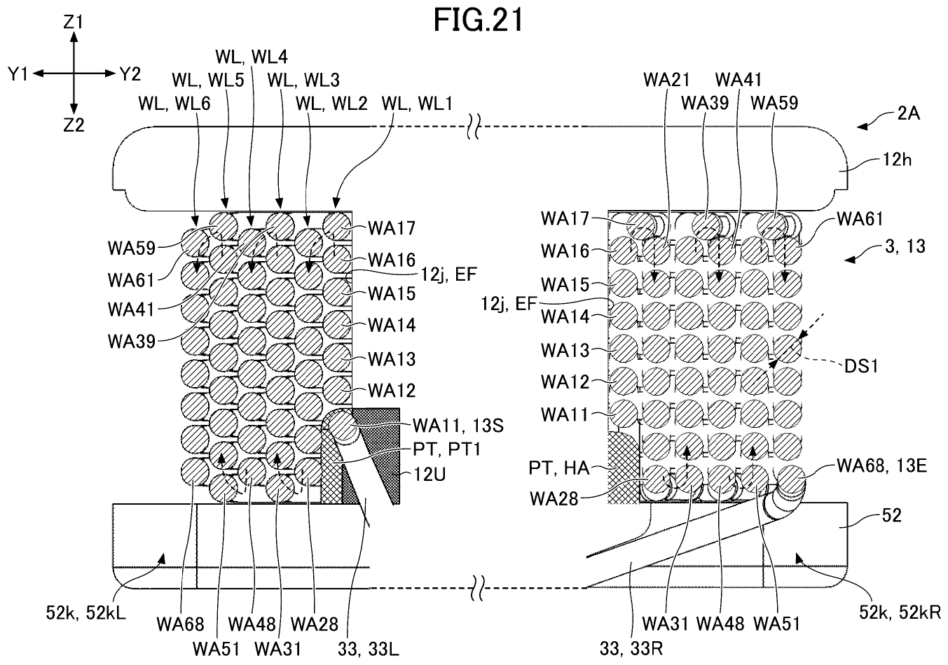

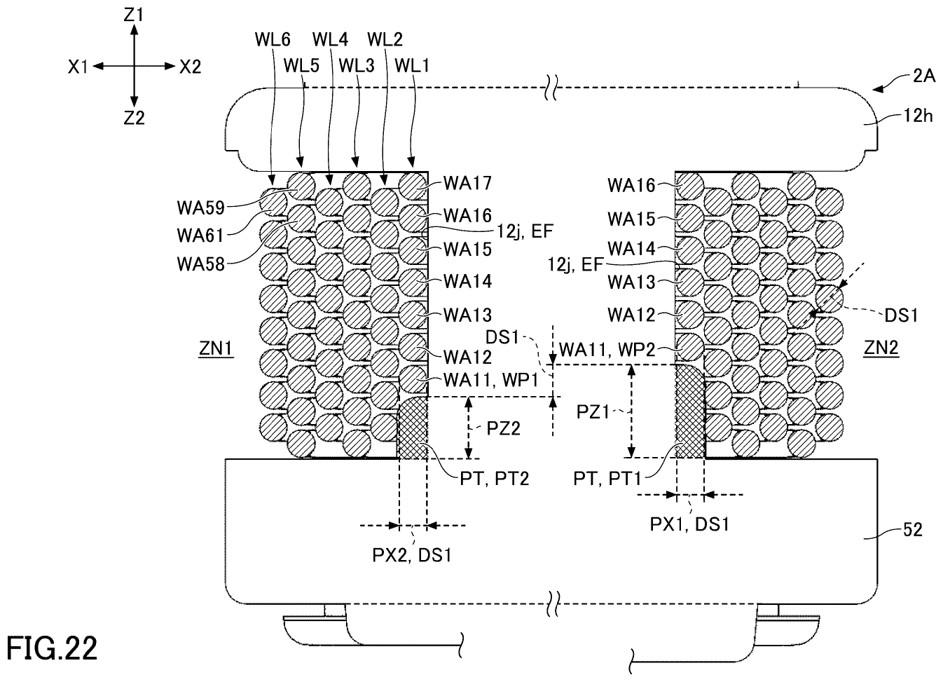

Next, with reference to FIGS. 18 to 22, the lens holding member 2A, which is another configuration example of the lens holding member 2, will be described. FIGS. 18 to 22 are drawings of the lens holding member 2A viewed from the direction perpendicular to the optical axis direction. Specifically, the upper drawing of FIG. 18 is a front view of the lens holding member 2A, which corresponds to the upper drawing of FIG. 13. The lower drawing of FIG. 18 is a cross-sectional view of the lens holding member 2A wound with the coil 3, which corresponds to the lower drawing of FIG. 13. The upper drawing of FIG. 19 is a right side view of the lens holding member 2A, which corresponds to the upper drawing of FIG. 14. The lower drawing of FIG. 19 is a cross-sectional view of the lens holding member 2A wound with the coil 3, and corresponds to the lower drawing of FIG. 14. The upper drawing of FIG. 20 is a rear view of the lens holding member 2A, and corresponds to the upper drawing of FIG. 15. The lower drawing of FIG. 20 is a left side view of the lens holding member 2A, and corresponds to the lower drawing of FIG. 15. FIGS. 21 and 22 are cross-sectional views of the lens holding member 2A and the coil 3. FIG. 21 corresponds to FIG. 16, and FIG. 22 corresponds to FIG. 17. Specifically, a left drawing of FIG. 21 is an enlarged view of the range R6 enclosed by the broken line in the lower drawing of FIG. 18, and a right drawing of FIG. 21 is an enlarged view of the range R7 enclosed by the broken line in the lower drawing of FIG. 18. A left drawing of FIG. 22 is an enlarged view of the range R8 enclosed by the broken line in the lower drawing of FIG. 19, and a right drawing of FIG. 22 is an enlarged view of the range R9 enclosed by the broken line in the lower drawing of FIG. 19. In FIGS. 21 and 22, a cross-sectional pattern (diagonal line pattern) is added to the cross section of the wires constituting the coil 3 for clarity.

In the lens holding member 2X shown in the upper drawing of FIG. 11 and the upper drawing of FIG. 12, when the number of turns of the winding part 13 is reduced in order to adjust the resistance value of the wires of the coil 3, the number of turns (the number of wire annular portions WA) of the outermost sixth layer WL6 is reduced. Further, if the number of the wire annular portions WA in the outermost layer closest to the magnet 5 decreases, the thrust generated by the driving part DM decreases more than when the number of the wire annular portions WA constituting the inner layer decreases.

Therefore, the lens holding member 2A shown in FIGS. 18 to 22 is configured so that the number of turns (the number of the wire annular portions WA) of the first layer WL1, which is the innermost layer, can be reduced by two by providing a protrusion PT on the outer peripheral surface EF of the coil supporting part 12j, which is the portion around which the wire is wound. In FIGS. 18 to 20, a dot pattern is applied to the surface of the protrusion PT for clarity. In FIGS. 21 and 22, a cross pattern is applied to the cross section of the protrusion PT for clarity.

The lens holding member 2A differs from the lens holding member 2 in that the protrusions PT include the second protrusion PT2, but is the same as the lens holding member 2 in other respects.

Like the first protrusion PT1, the second protrusion PT2 extends parallel to the XY plane and is a portion whose height in the Z-axis direction does not change. As shown in FIG. 22, the second protrusion PT2 is configured to be lower than the first protrusion PT1 by the thickness DS1 of the wire. In the illustrated example, the second protrusion PT2 is configured to have a height equivalent to twice the thickness DS1 of the wire so that the number of turns (the number of wire annular portions WA) of the first layer WL1, which is the innermost layer, can be reduced by two. The second protrusion PT2 may be configured to have a height equivalent to three or more times the thickness DS1 of the wire so that the number of turns (the number of wire annular portions WA) of the first layer WL1, which is the innermost layer, can be reduced by three or more.

This configuration can adjust the resistance value of the wire of the coil 3 while suppressing decrease in thrust generated by the driving part DM by reducing the number of wire annular portions WA in the innermost layer furthest from the magnet 5 instead of reducing the number of wire annular portions WA in the outermost layer closest to the magnet 5.

As described above, as shown in FIG. 2, the lens driving apparatus 101 according to the present embodiment has a fixed member FB, a lens holding member 2 having a tubular part 12 capable of holding a lens body, flat springs 6 (upper flat spring 16 and lower flat springs 26) as supporting members for supporting the lens holding member 2 movably in the optical axis direction (Z-axis direction), a coil 3 provided at least on the outside of the tubular part 12 of the lens holding member 2, and a driving part DM that includes a plurality (four) of magnets 5 facing the coil 3 and moves the lens holding member 2 in the optical axis direction with respect to the fixed member FB. The lens holding member 2 has a flange 52 projecting outward in the radial direction from the outer peripheral surface EF of the tubular part 12, and a regulation part 12h facing the flange 52 at a distance in the optical axis direction. In the flange 52, two notches 52k (left notch 52kL and right notch 52kR) are formed at positions opposite each other across the tubular part 12, and holding parts 72 are provided corresponding to each of the two notches 52k. The coil 3 has a winding part 13 formed by winding a wire around the outer periphery of the tubular part 12 between one surface (surface facing Z1 direction) of the flange 52 and one surface (surface facing Z2 direction) of the regulation part 12h, a first extended part (left extended part 33L) connected to the winding start part 13S of the winding part 13, and a second extended part (right extended part 33R) connected to the winding end part 13E of the winding part 13. The first extended part (left extended part 33L) passes through the first notch (left notch 52kL) and is held by the first holding part (left holding part 72L), and the second extended part (right extended part 33R) passes through the second notch (right notch 52kR) and is held by the second holding part (right holding part 72R).

As shown in FIGS. 16 and 17, the winding part 13 has a plurality (six) of winding layers WL which are stacked radially outward from the outer peripheral surface EF of the tubular part 12 (coil supporting part 12j). As shown in FIG. 17, a first turn of a wire annular portion WA (first wire annular portion WA11) of the winding part 13 connected to the first extended part (left extended part 33L) includes a first portion WP1 and a second portion WP2, the first portion WP1 being positioned in a first region ZN1 extending from the first notch (left notch 52kL) to the second notch (right notch 52kR) in a circumferential direction along the outer peripheral surface EF of the tubular part 12 (a direction parallel to the XY plane in which the wire is wound), the second portion WP2 being positioned in a second region ZN2 extending from the second notch (right notch 52kR) to the first notch (left notch 52kL) in the circumferential direction, the second region ZN2 being different from the first region ZN1, and the second portion WP2 being located nearer to the regulation part 12h (in Z1 direction) than the first portion WP1 by a distance substantially equal to a thickness DS1 of the wire. In the example shown in FIG. 17, the first turn of the wire annular portion WA (first wire annular portion WA11) of the winding part 13 is wound around the second region ZN2 after being wound around the first region ZN1. That is, in the first turn of the wire annular portion WA (first wire annular portion WA11) of the winding part 13, the first portion WP1 existing in the first region ZN1 is connected to the first extended part (left extended part 33L).

This configuration has the effect that the number of wires constituting the outermost layer of the winding part 13 can be made the same over the entire circumference (360 degrees) of the tubular part 12. Therefore, this configuration has the effect that variations in the electromagnetic force generated by the coil 3 and the four magnets 5 in the circumferential direction of the tubular part 12 can be prevented. That is, this configuration has the effect that the difference in the electromagnetic force caused by the difference in the winding number of the wires can be prevented.

As shown in FIG. 17, in the second region ZN2, a first protrusion PT1 is provided at a corner section formed of one surface (surface facing Z1 direction) of the flange 52 and the outer peripheral surface EF of the tubular part 12 (coil supporting part 12j). The first turn of the wire annular portion WA (the second portion WP2 of the first wire annular portion WA11) is disposed in contact with the surface of the first protrusion PT1 in the direction (Z1 direction) of the regulation part 12h. The protruding length PX1 of the first protrusion PT1 radially outward from the outer peripheral surface EF of the tubular part 12 (coil supporting part 12j) is approximately equal to the thickness DS1 of the wire.

This configuration has the effect that the position (height in the Z-axis direction) of the first turn of the wire can be easily changed between the first region ZN1 and the second region ZN2 by the first protrusion PT1. This configuration also has the effect that the second layer WL2, which is an adjacent layer located adjacent to the first layer WL1, which is the innermost layer of the winding part 13, can be properly formed.

Further, as shown in FIG. 16, in the direction (Z2 direction) where the flange 52 is located on the outer peripheral surface EF of the tubular part 12 (coil supporting part 12j) and the portion corresponding to the second notch (right notch 52kR) (the portion where the second notch is formed), a height adjusting part HA in contact with the first turn of the wire annular portion WA (first wire annular portion WA11) is provided integrally with the tubular part 12 (coil supporting part 12j). That is, on the outer peripheral surface EF of the tubular part 12 (coil supporting part 12j), the height adjusting part HA is provided not in the direction (Y1 direction) corresponding to the first notch (left notch 52kL) but in the direction (Y2 direction) corresponding to the second notch (right notch 52kR). As is clear from the upper drawing of FIG. 14, the height position in the optical axis direction (Z-axis direction) of the first turn of the wire annular portion WA (first wire annular portion WA11) wound from the first region ZN1 toward the second region ZN2 gradually changes in the circumferential direction by the height adjusting part HA. In the illustrated example, the height adjusting part HA is formed continuously with the first protrusion PT1, but may be formed so as to line up with a gap between them.

Since the height of the wire (the wire annular portion WA) in the Z-axis direction can be gradually changed in this configuration, the occurrence of disorderly winding of the winding part 13 can be prevented.

In addition, as shown in FIG. 22, in the first region ZN1, the second protrusion PT2 may be provided at a corner section formed of one surface (surface facing Z1 direction) of the flange 52 and the outer peripheral surface EF of the tubular part 12 (coil supporting part 12j). In this case, the first wound wire annular portion WA (the first portion WP1 of the first wire annular portion WA11) is arranged in contact with the surface facing the direction of the regulation part 12h of the second protrusion PT2 (Z1 direction). The protruding length PX2 of the second protrusion PT2 radially outward from the outer peripheral surface EF of the tubular part 12 (coil supporting part 12j) is approximately equal to the thickness DS1 of the wire. The protruding length PZ1 of the first protrusion PT1 toward the direction of the regulation part 12h (Z1 direction) is larger than the protruding length PZ2 of the second protrusion PT2 toward the direction of the regulation part 12h (Z1 direction) by approximately the same length as the thickness DS1 of the wire.

This configuration has the effect that the number of wires in the outermost layer (sixth layer WL6) close to the magnet 5 can be increased by adjusting the protruding lengths of the first protrusion PT1 and the second protrusion PT2 in the optical axis direction.

Further, as shown in FIG. 22, the protruding length PZ1 of the first protrusion PT1 toward the direction (Z1 direction) of the regulation part 12h with respect to one surface (surface facing the Z1 direction) of the flange 52 is desirably a natural number multiple of the thickness DS1 of the wire, the number of winding layers WL constituting the winding part 13 is even, the number of turns of the wire constituting the outermost layer of the winding part 13 is one less than the number of turns of the wire constituting the adjacent layer, which is the second layer from the outside adjacent to the outermost layer, and the wire constituting the adjacent layer is disposed over the entire region between one surface (surface facing the Z1 direction) of the flange 52 and the regulation part 12h, and the wire constituting the outermost layer has each of the plurality of wire annular portions WA constituting the outermost layer, and the wire constituting the adjacent layer is disposed so as to be positioned between two wire annular portions WA adjacent to each other in the optical axis direction.

In the example shown in FIG. 22, the protruding length PZ1 of the first protrusion PT1 toward the direction (Z1 direction) of the regulation part 12h is three times the thickness DS1 of the wire, the number of winding layers WL constituting the winding part 13 is six, the number of turns (eight turns) of the wire constituting the outermost layer (sixth layer) of the winding part 13 is one less than the number of turns (nine turns) of the wire constituting the adjacent layer (fifth layer) which is the second layer from the outside adjacent to the outermost layer, the wire constituting the adjacent layer (fifth layer) is disposed without a gap over the entire region between one surface (surface facing Z1 direction) of the flange 52 and the regulation part 12h, and with respect to the wire constituting the outermost layer (sixth layer), each of the eight wire annular portions WA constituting the outermost layer (sixth layer) is arranged so as to be located between two adjacent wire annular portions WA constituting the adjacent layer (fifth layer) in the optical axis direction (Z-axis direction). Specifically, the first wire annular portion WA61 constituting the outermost layer (sixth layer) farthest from the tubular part 12 is arranged so as to be located between the eighth wire annular portion WA58 and the ninth wire annular portion WA59 constituting the adjacent layer (fifth layer) in the Z-axis direction.

This arrangement has the effect that the number of wires in the outermost layer (sixth layer WL6) is increased and the thrust by the driving part DM can be increased.

Thus, the preferred embodiment of the present invention has been described in detail. However, the present invention is not limited to these embodiments, but various variations and modifications may be made without departing from the scope of the present invention.

For example, in the above-described embodiment, the base member 18 constitutes a fixed member FB, but may also constitute a movable member (a magnet holding member in a lens driving apparatus having an optical shake correction function) for holding the magnet 5.

What is claimed is:

1. A lens driving apparatus comprising:
a fixed member;
a lens holding member having a tubular part capable of holding a lens body;
a support member configured to movably support the lens holding member in an optical axis direction; and
a driving part that has at least a coil provided outside the tubular part of the lens holding member and a plurality of magnets facing the coil, and that moves the lens holding member in the optical axis direction,
wherein the lens holding member has a flange protruding radially outward from a surface of an outer periphery of the tubular part, and a regulation part facing the flange and spaced from the flange in the optical axis direction,
wherein the flange has a first notch and a second notch formed at positions opposite each other across the tubular part, a first holding part provided corresponding to the first notch, and a second holding part provided corresponding to the second notch,
wherein the coil has a winding part formed by winding a wire around the outer periphery of the tubular part between one surface of the flange part and the regulation part, a first extended part connected to a winding start part of the winding part, and a second extended part connected to a winding end part of the winding part,
wherein the first extended part passes through the first notch and is held by the first holding part, and the second extended part passes through the second notch and is held by the second holding part,
wherein the winding part has a plurality of winding layers stacked radially outward from an outer peripheral surface of the tubular part, and
wherein a first turn of a wire annular portion of the winding part connected to the first extended part includes a first portion and a second portion, the first portion being positioned in a first region extending from the first notch to the second notch in a circumferential direction along the outer peripheral surface of the tubular part, the second portion being positioned in a second region extending from the second notch to the first notch in the circumferential direction, the second region being different from the first region, and the second portion being located nearer to the regulation part than the first portion by a distance substantially equal to a thickness of the wire.

2. The lens driving apparatus according to claim 1, wherein:
in the second region, a first protrusion is provided at a corner section formed of the one surface of the flange and the outer peripheral surface of the tubular part;
the first turn of the wire annular portion is disposed in contact with a surface of the first protrusion facing the regulation part; and
a protruding length of the first protrusion extending radially outward from the outer peripheral surface of the tubular part is substantially equal to the thickness of the wire.

3. The lens driving apparatus according to claim 2, wherein:
a height adjusting part in contact with the first turn of the wire annular portion is provided integrally with the tubular part at a position corresponding to the second notch; and
a height position of the first turn of the wire annular portion wound from the first region toward the second region in the optical axis direction is gradually changed in a circumferential direction by the height adjusting part.

4. The lens driving apparatus according to claim 2, wherein:
in the first region, a second protrusion is provided at the corner section formed of the one surface of the flange and the outer peripheral surface of the tubular part;
the first turn of the wire annular portion is disposed in contact with a surface of the second protrusion facing the regulation part;
a protruding length of the second protrusion radially outward from the outer peripheral surface of the tubular part is substantially equal to the thickness of the wire; and
the protruding length of the first protrusion toward the regulation part is larger than the protruding length of the second protrusion toward the regulation part by a length substantially equal to the thickness of the wire.

5. The lens driving apparatus according to claim 4, wherein:
the protruding length of the first protrusion toward the regulation part is a natural number multiple of the thickness of the wire;
a number of the winding layers constituting the winding part is an even number;
a number of turns of the wire constituting an outermost layer of the winding part is one less than a number of turns of the wire constituting an adjacent layer which is a second layer from an outside adjacent to the outermost layer;
the wire constituting the adjacent layer is disposed over an entire region between the one surface of the flange and the regulation part; and
the wire constituting the outermost layer is disposed so that each of a plurality of annular portions of the wire constituting the outermost layer is positioned between two annular portions of the wire which are adjacent in the optical axis direction, the two annular portions being annular portions of the adjacent layer.

6. A camera module comprising the lens driving apparatus according to claim 1, the lens body, and an imaging sensor facing the lens body.
